(19) United States
(12) Patent Application Publication
(10) Pub. No.: US 2008/0087269 A1
(43) Pub. Date: Apr. 17, 2008

(54) Grill for roasting meat

(76) Inventor: Ho-Il Kang, Ulsan (KR)

Correspondence Address: DUANE MORRIS, LLP;IP DEPARTMENT, 30 SOUTH 17TH STREET, PHILADELPHIA, PA, 19103-4196, US

(21) Appl. No.: 11/711,973

(22) Filed: Feb. 28, 2007

(30) Foreign Application Priority Data
Oct. 13, 2006 (KR) 10-2006-0099731
Jan. 16, 2007 (KR) 10-2007-0004742

(51) Int. Cl. A47J 37/06; A47J 37/07

(52) U.S. Cl. 126/25 A; 126/25 AA; 126/25 R

(57) ABSTRACT

A grill for roasting a meat includes: a peripheral frame; a plurality of first support frames connected to the peripheral frame, the plurality of first support frames parallel to and spaced apart from one another by a first space; and a plurality of second support frames under the plurality of first support frames, the plurality of second support frames parallel to and spaced apart from one another by a second space, each of the plurality of second support frames corresponding to the first space.

This application claims the benefit of Korean Patent Application No. 2006-0099731, filed on Oct. 13, 2006 and Korean Patent Application No. 2007-0004742, filed on Jan. 16, 2007, which are hereby incorporated by references for all purposes as if fully set forth herein.

### BACKGROUND OF THE INVENTION

1. Field of the Invention

The present invention relates to a grill, and more particularly, to a grill for roasting a meat where a contact area between the grill and the meat is minimized and remnants of the meat are easily collected.

2. Discussion of the Related Art

In general, various types of grills have been used for roasting a meat or a fish. For example, a grill of a pan shape without holes for fire, a grill having holes for fire and a gridiron of a lattice shape have been widely used, and a fire from charcoal or gas has been used as a heat source. The grill of a pan shape without holes for fire may have an outlet extracting a grease of the meat. In addition, a central portion is higher than a boundary portion and a plane from the central portion to the boundary portion is slanted so that the grease of the meat can flow to the boundary portion. After the heat source begins to heat the grill of a pan shape without holes for fire, it is difficult to control a temperature of the grill. Further, since the grill contacts a meat with a large contact area, the grease of the meat is apt to be sputtered with a moist of the meat and the meat is apt to be scorched to adhere to the grill.

In the grill having holes for fire or the gridiron of a lattice shape, since a flame of the heat source is directly applied to a meat through the holes for fire or gaps of the lattice shape, the meat is apt to be scorched. In addition, since the grease of the meat drops onto the heat source to cause an instantaneous flame and a large amount of smoke, excellent ventilation facilities are required. Further, even though the meat is roasted in a short time due to a direct application of the flame of the heat source, gravy is transpired from the meat and the meat is scorched when the meat is over-roasted.

Accordingly, when a meat is roasted using one of the grill of a pan shape without holes for fire, the grill having holes for fire and the gridiron of a lattice shape, the meat is scorched to cause a smoke and a smell. Moreover, carcinogen from the scorched meat is harmful for health.

### SUMMARY OF THE INVENTION

Accordingly, the present invention is directed to a grill for roasting a meat that substantially obviates one or more of the problems due to limitations and disadvantages of the related art.

An advantage of the present invention is to provide a grill for roasting a meat where a scorch of the meat is prevented by minimizing a contact area between the grill and the meat.

Another advantage of the present invention is to provide a grill for roasting a meat where remnants of the meat are easily collected.

Another advantage of the present invention is to provide a grill for roasting a meat where remnants of the meat are prevented from being scorched by reducing a thermal conduction to a guide path.

Another advantage of the present invention is to provide a grill for roasting a meat which is easily cleaned.

Additional features and advantages of the invention will be set forth in the description which follows, and in part will be apparent from the description, or may be learned by practice of the invention. These and other advantages of the invention will be realized and attained by the structure particularly pointed out in the written description and claims hereof as well as the appended drawings.

To achieve these and other advantages and in accordance with the purpose of the present invention, as embodied and broadly described, a grill for roasting a meat includes: a peripheral frame; a plurality of first support frames connected to the peripheral frame, the plurality of first support frames parallel to and spaced apart from one another by a first space; and a plurality of second support frames under the plurality of first support frames, the plurality of second support frames parallel to and spaced apart from one another by a second space, each of the plurality of second support frames corresponding to the first space.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view showing a grill according to a first embodiment of the present invention;

FIG. 2 is a perspective view showing an upper plate of a grill according to a first embodiment of the present invention;

FIG. 3 is a perspective view showing a lower plate of a grill according to a first embodiment of the present invention;

FIG. 4 is a perspective view showing a cut grill according to a first embodiment of the present invention;

FIG. 5 is a plan view showing an upper plate of a grill according to a first embodiment of the present invention;

FIG. 6 is a plan view showing a lower plate of a grill according to a first embodiment of the present invention;

FIG. 7 is a plan view showing a grill according to a first embodiment of the present invention;

FIG. 8 is a perspective view showing a grill according to a second embodiment of the present invention;

FIG. 9 is a perspective view showing an upper plate of a grill according to a second embodiment of the present invention;

FIG. 10 is a perspective view showing a middle plate of a grill according to a second embodiment of the present invention;

FIG. 11 is a perspective view showing a lower plate of a grill according to a second embodiment of the present invention;

FIG.12 is a perspective view showing a cut grill according to a second embodiment of the present invention;

FIG. 13 is an exploded perspective view showing a cut grill according to a second embodiment of the present invention;

FIG. 14 is a plan view showing an upper plate of a grill according to a second embodiment of the present invention;

FIG. 15 is a plan view showing a middle plate of a grill according to a second embodiment of the present invention;

FIG. 16 is a plan view showing a lower plates of a grill according to a second embodiment of the present invention

FIG. 17 is a plan view showing a grill according to a second embodiment of the present invention;

FIG. 18 is a perspective view showing a cut grill according to a third embodiment of the present invention;

FIG. 19 is an exploded perspective view showing a cut grill according to a third embodiment of the present invention;

FIG. 20 is a perspective view showing a cut second support frame having a continuous side part of a grill according to a third embodiment of the present invention; and

FIG. 21 is a perspective view showing a cut second support frame having a punched side part of a grill according to a third embodiment of the present invention.

### DETAILED DESCRIPTION OF THE ILLUSTRATED EMBODIMENTS

Reference will now be made in detail to embodiments of the present invention, example of which are illustrated in the accompanying drawings.

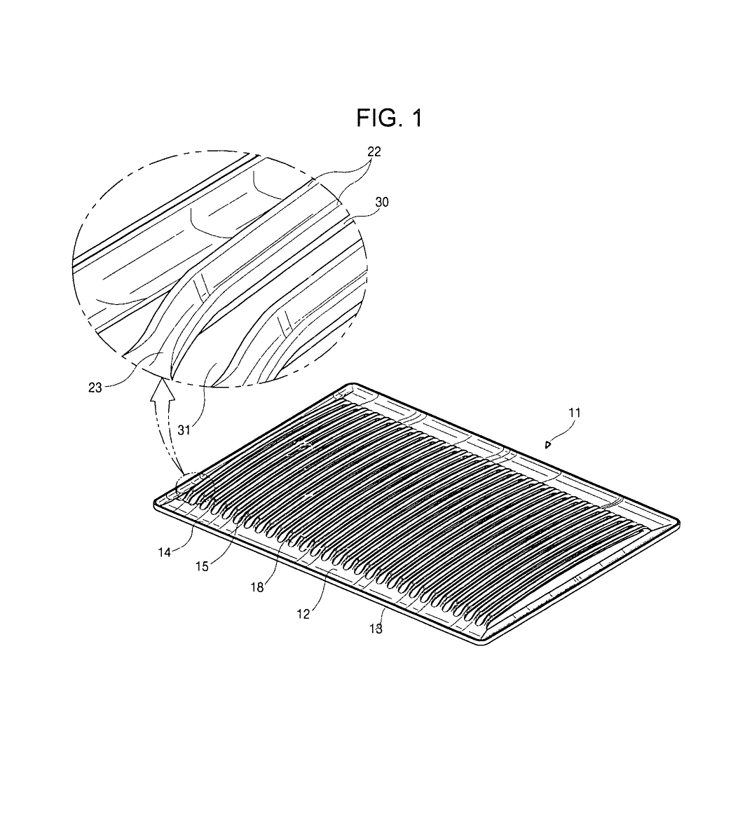

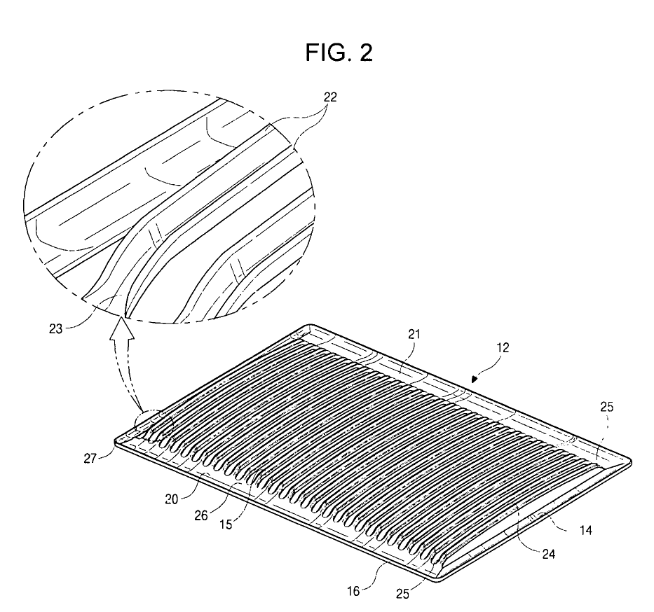

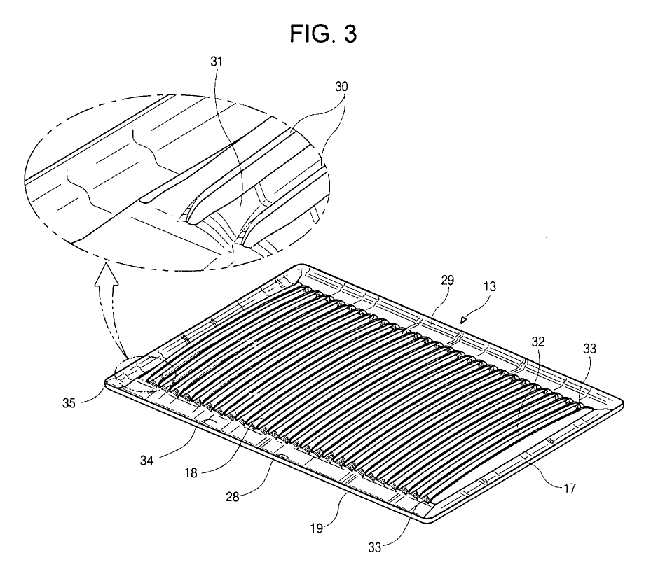

FIG. 1 is a perspective view showing a grill according to a first embodiment of the present invention, and FIGS. 2 and 3 are perspective views showing upper and lower plates of a grill according to a first embodiment of the present invention, respectively.

As shown in FIGS. 1 to 3, a grill 11 includes an upper plate 12 and a lower plate 13 combined with the upper plate 12. The upper plate 12 includes a first peripheral frame 14, a plurality of first support frames 15 and a first fence 16, and the lower plate 13 includes a second peripheral frame 17, a plurality of second support frames 18 and a second fence 19. The first and second peripheral frames 14 and 17 have a tetragonal shape. The plurality of first support frames 15 are parallel to and spaced apart from one another inside the first peripheral frame 14, and the plurality of second support frames 18 are parallel to and spaced apart from one another inside the second peripheral frame 17. In addition, the first and second fences 16 and 19 surround the first and second peripheral frames 14 and 17, respectively.

The first peripheral frame 14 includes first and second long frames 20 and 21 parallel to each other, and each of the plurality of first support frames 15 is connected to the first and second long frames 20 and 21. In addition, each of the plurality of first support frames 15 includes two first side parts 22 to form a first guide path 23. While a meat is roasted, the meat directly contacts the first side parts 22 and remnants extracted from the meat while roasting are guided through the first guide path 23. Each of the plurality of first support frames 15 is highest at a first central portion 24 and lowest at first connection portions 25 where each of the plurality of first support frames 15 is connected to the first and second long frames 20 and 21. Accordingly, each of the plurality of first support frames 15 is gently slanted between the first central portion 24 and the first connection portion 25. A first inclined plane 26 slanted toward the first fence 16 is formed between the first peripheral frame 14 and the first fence 16, and a first gathering part 27 of a moat shape is disposed between the first inclined plane 26 and the first fence 16 to gather remnants of the meat. The first gathering part 27 is formed along an inner surface of the first fence 16.

The second peripheral frame 18 includes third and fourth long frames 28 and 29 parallel to each other, and each of the plurality of second support frames 18 is connected to the third and fourth long frames 28 and 29. In addition, each of the plurality of second support frames 18 includes two second side parts 30 to form a second guide path 31. While a meat is roasted, the remnants of the meat are guided through the second guide path 31. Each of the plurality of second support frames 18 is highest at a second central portion 32 and lowest at second connection portions 33 where each of the plurality of second support frames 18 is connected to the third and fourth long frames 28 and 29. Accordingly, each of the plurality of second support frames 18 is gently slanted between the second central portion 32 and the second connection portion 33. A second inclined plane 34 slanted toward the second fence 19 is formed between the second peripheral frame 17 and the second fence 19, and a second gathering part 35 of a moat shape is disposed between the second inclined plane 34 and the second fence 19 to gather remnants of the meat. The second gathering part 35 is formed along an inner surface of the second fence 19.

As shown in FIG. 1, when the upper and lower plates 12 and 13 are combined to each other, an outer surface of the first fence 16 of the upper plate 12 contacts an inner surface of the second fence 19 of the lower plate 13 and the first gathering part 27 of the upper plate 12 is disposed over the second gathering part 35 of the lower plate 13. Each of the plurality of second support frames 18 of the lower plate 13 is aligned to a space between adjacent two first support frames 15 of the upper plate 12. The first and second support frames 15 and 18 do not contact and are spaced apart from each other so that heat from a heat source (not shown) such as a charcoal fire under the grill 11 can be transmitted to the meat on the upper plate 12.

Since the space between adjacent two first support frames 15 corresponds to each of the plurality of second support frames 18, drop of the remnants of the meat on the upper plate 12 onto the heat source is prevented. Accordingly, a width of the space between adjacent two first support frames 15 is smaller than a width of each of the plurality of second support frames 18. The grill 11 further includes an adjusting means (not shown) adjusting a vertical gap distance between the plurality of first support frames 15 and the plurality of second support frames 18 to control the heat conduction from the heat source to the upper plate 12. In addition, the grill 11 further includes an outlet at the first gathering part 27 of the upper plate 12 and the second gathering part 35 of the lower plate 13 to extract the remnants of the meat.

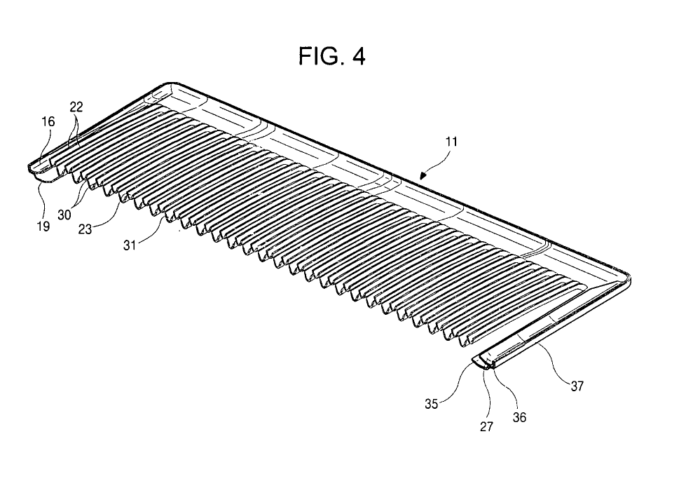

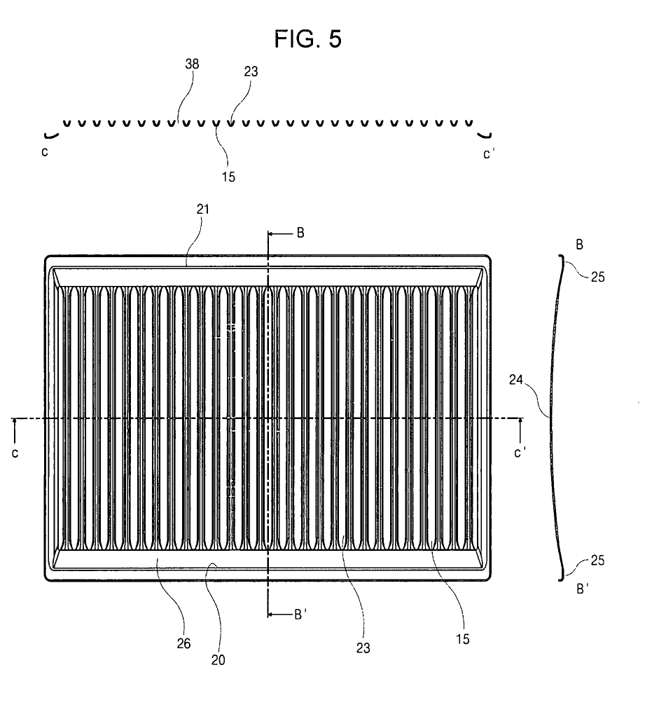

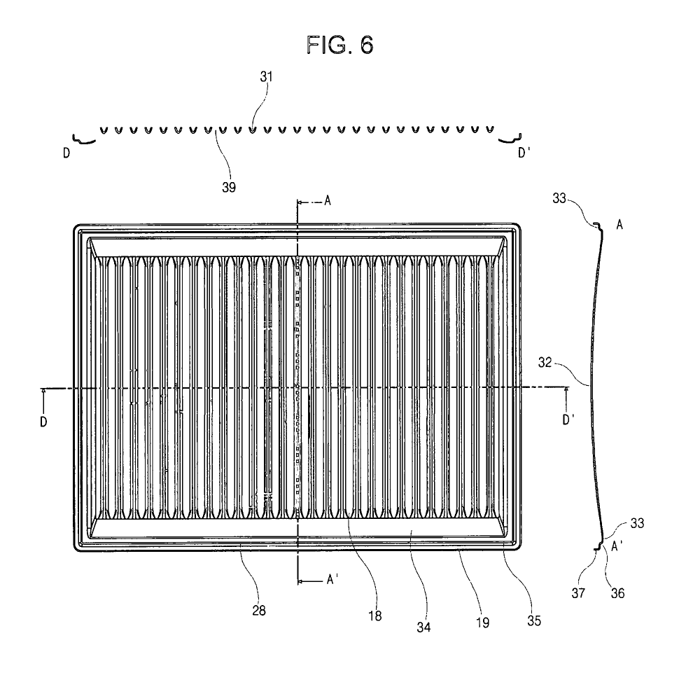

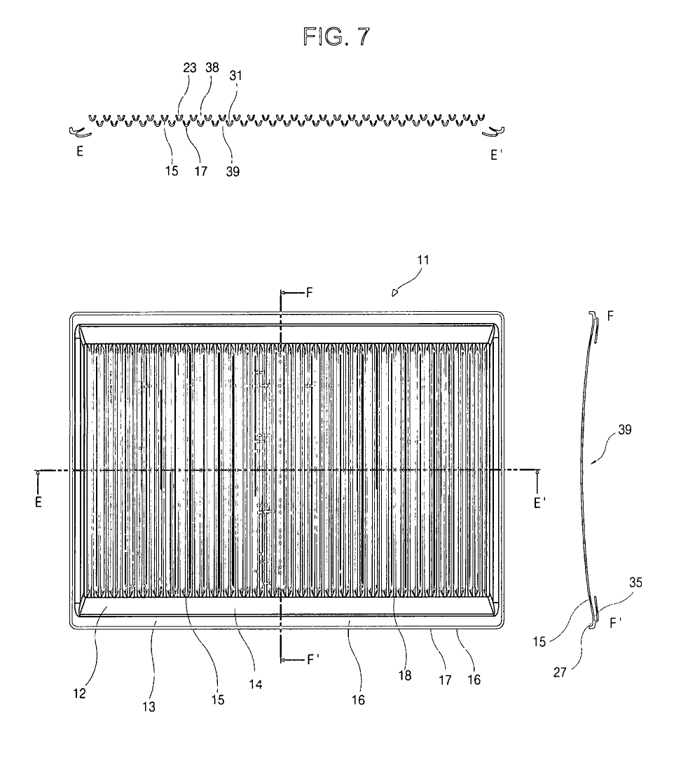

FIG. 4 is a perspective view showing a cut grill according to a first embodiment of the present invention. FIGS. 5 and 6 are plan views showing upper and lower plates of a grill according to a first embodiment of the present invention, respectively, and FIG. 7 is a plan view showing a grill according to a first embodiment of the present invention. In addition, FIG. 5 shows cross-sections of the upper plate taken along lines “B-B′” and “C-C′,” and FIG. 6 shows cross-sections of the lower plate taken along lines “A-A′” and “D-D′.” FIG. 7 shows cross-sections of the grill taken along lines “E-E′” and “F-F′.”

As shown in FIG. 4, an outer surface of the first fence 16 of the upper plate 12 contacts an inner surface of the second fence 19 of the lower plate 13. The second fence 19 of the lower plate 13 includes an upper plate supporting part 36 bending and outwardly extending and an upper plate contact part 37 vertically extending from an end portion of the upper plate supporting part 37 to support the upper plate 12. The upper plate contact part 37 contacts the first fence 16. Accordingly, in the grill 11 having the combined upper and lower plates 12 and 13, the upper plate 12 is supported by the upper plate supporting part 36 of the lower plate 12. In addition, the first gathering part 27 of the upper plate 12 and the second gathering part 35 of the lower plate 13 independently gather the remnants of the meat through the first guide path 23 of the plurality of first support frames 15 of the upper plate 12 and the second guide path 31 of the plurality of second support frames 18 of the lower plate 13. The plurality of first support frames 15 of the upper plate 12 and the plurality of second support frames 18 of the lower plate 13 are spaced apart without contact so that the heat from the heat source such as a charcoal fire can be transmitted to the plurality of first support frames 15 of the upper plate 12.

As shown in FIG. 5, each of the plurality of first support frames 15 is highest at the first central portion 24 and lowest at the first connection portions 25 where each of the plurality of first support frames 15 is connected to the first and second long frames 20 and 21 with respect to the first peripheral frame 14. Accordingly, each of the plurality of first support frames 15 is gently slanted such that the height is lowered from the first central portion 24 to the first connection portion 25. As a result, the remnants of the meat does not stay in the first guide path 23 and are gathered in the first gathering part 27 due to a slant shape of the plurality of first support frames 15. Since the remnants of the meat from the first guide path 23 flow between the first inclined plane 26 and the first fence 16, the remnants of the meat are easily gathered in the first gathering part 27. Accordingly, the amount of the remnants of the meat remaining on the plurality of first support frame 15 of the upper plate 12 corresponding to the heat source is minimized. Further, the plurality of first support frames 15 are parallel to and spaced apart from one another by a first space 38 and each of the plurality of second support frames 18 corresponds to the first space 38.

As shown in FIG. 6, each of the plurality of second support frames 18 is highest at the second central portion 32 and lowest at the second connection portions 33 where each of the plurality of second support frames 18 is connected to the third and fourth long frames 28 and 29 with respect to the second peripheral frame 17. Accordingly, each of the plurality of second support frames 18 is gently slanted such that the height is lowered from the second central portion 32 to the second connection portion 33. As a result, the remnants of the meat does not stay in the second guide path 31 and are gathered in the second gathering part 35 due to a slant shape of the plurality of second support frames 18. Since the remnants of the meat from the second guide path 31 flow between the second inclined plane 34 and the second fence 19, the remnants of the meat are easily gathered in the second gathering part 35. Accordingly, the amount of the remnants of the meat remaining on the plurality of second support frame 18 of the lower plate 13 corresponding to the heat source is minimized. Further, the plurality of second support frames 18 are parallel to and spaced apart from one another by a second space 39 and each of the plurality of first support frames 15 corresponds to the second space 39.

Referring to the cross-section taken along line “F-F′” of FIG. 7, since the plurality of first support frames 15 of the upper plate 12 correspond to the plurality of second spaces 39 of the lower plate 13, the second support frame 18 is not shown and the second space 39 is disposed under the first support frame 15. Referring to the cross-section taken along line “E-E′” of FIG. 7, the plurality of first support frames 15 of the upper plate 12 are parallel to and spaced apart from one another by the first space 38 and the plurality of second support frames 18 of the lower plate 13 are parallel to and spaced apart from one another by the second space 39. In addition, each of the plurality of second support frames 18 corresponds to the first space 38. The width of each of the plurality of first support frames 15 of the upper plate 12 is greater than the second space 39 of the lower plate 13, and the width of each of the plurality of second support frames 18 of the lower plate 13 is greater than the first space 38 of the upper plate 12. Accordingly, the plurality of first support frames 15 overlap the plurality of second support frames 18 at their side portions so that drop of the remnants on the plurality of first support frames 15 onto the heat source can be prevented.

Each of the plurality of first support frames 15 and the plurality of second support frames 18 has a cross-sectional shape such that a width is gradually reduced from an upper portion to a lower portion. The lowest portion of the cross-sectional shape is rounded. For example, the cross-sectional shape of the plurality of first support frames 15 and the plurality of second support frames 18 may have a triangular shape or a U shape. At least one outlet (not shown) is further formed at each of the first and second gathering parts 27 and 35 to prevent overflow of the remnants. Further, the grill 11 includes a metallic material having a relatively high heat conductivity such as aluminum (Al). The surface of the grill 11 may be enameled or coated with Teflon.

The process of roasting a meat using the grill 11 according to a first embodiment of the present invention will be illustrated hereinafter. When the upper and lower plates 12 and 13 are combined, the first peripheral frame 14 of the upper plate 12 is disposed on the upper plate supporting part 36 of the lower plate 13 and the outer surface of the first fence 16 of the upper plate 12 contacts the inner surface of the second fence 19 of the lower plate 13. In addition, each of the plurality of first support frames 15 of the upper plate 12 is aligned to the second space 39 of the lower plate 13 and each of the plurality of second support frames 18 is aligned to the first space 38 of the upper plate 12. The plurality of first support frames 15 of the upper plate 12 are spaced apart from the plurality of second support frames 18 of the lower plate 13 so that the heat of the heat source under the grill 11 can be applied to the upper plate 12.

The heat source such as a charcoal fire is disposed under the grill 11 and the meat is disposed on the plurality of first support frames 15 of the upper plate 12. The heat source heats the plurality of second support frames 18 of the lower plate 13 and the heat of the heat source is supplied through a space between the plurality of first support frames 15 and the plurality of second support frames 18 to heat tie plurality of first support frames 15. Since the meat contacts a top surface of the two first side parts 22 of each first support frame 15, the contact area of the meat and the upper plate 12 is minimized. Further, since the plurality of second support frames 18 are disposed under the plurality of first support frames 15, the meat does not directly contact the lower plate 13. The meat is roasted by the plurality of first support frames 15 heated by the heat source and the heat supplied through the space between the plurality of first support frames 15 and the plurality of second support frames 18. As a result, the scorch of the meat is prevented due to the minimization of the contact area.

When the meat is roasted, the remnants such as grease are extracted from the meat and are guided through the first and second guide paths 23 and 31. The remnants in the first and second guide paths 23 and 31 heated by the heat source are evaporated and permeate into the entire meat to cause a marbling effect. Grease of a shape of frost in a meat is referred to as a marbling, which is a key factor determining quality of a meat. The marbling generates a film on a surface of the meat and prevents evaporation of moist. In addition, the marbling prevents moist generation by degeneration of protein and extraction of gravy to soften the meat.

The remnants except the evaporated amount are gathered in the first gathering part 27 of the upper plate 12 and the second gathering part 35 of the lower plate 13 through the first and second guide paths 23 and 31. Since the plurality of first support frames 15 overlap the plurality of second support frames 18 at their side portions, the remnants do not drop onto the heat source.

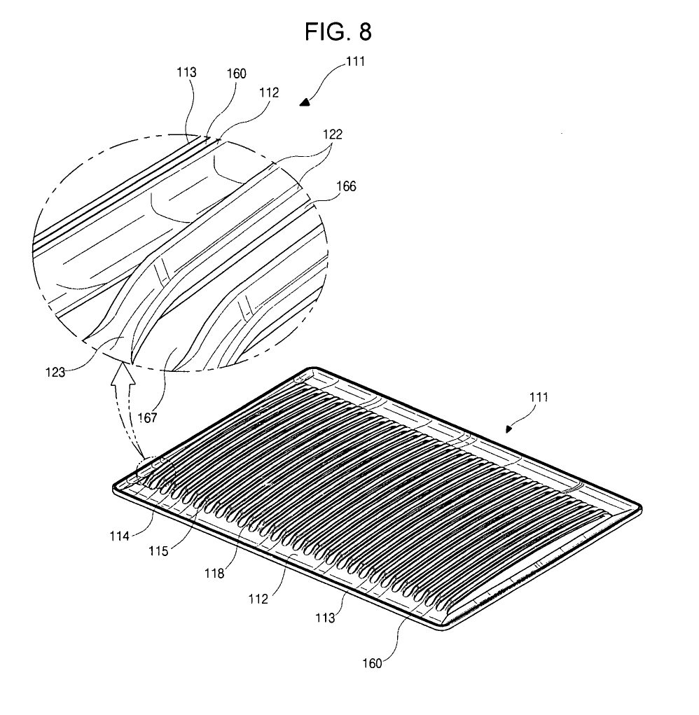

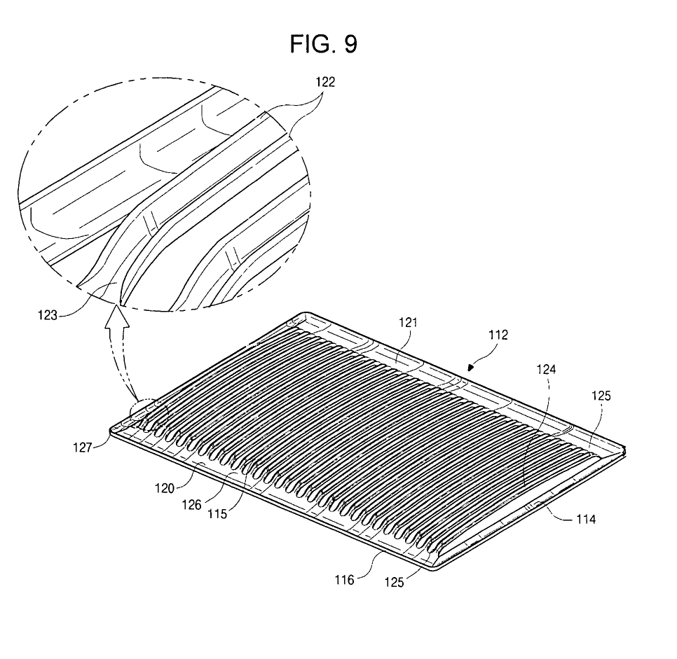

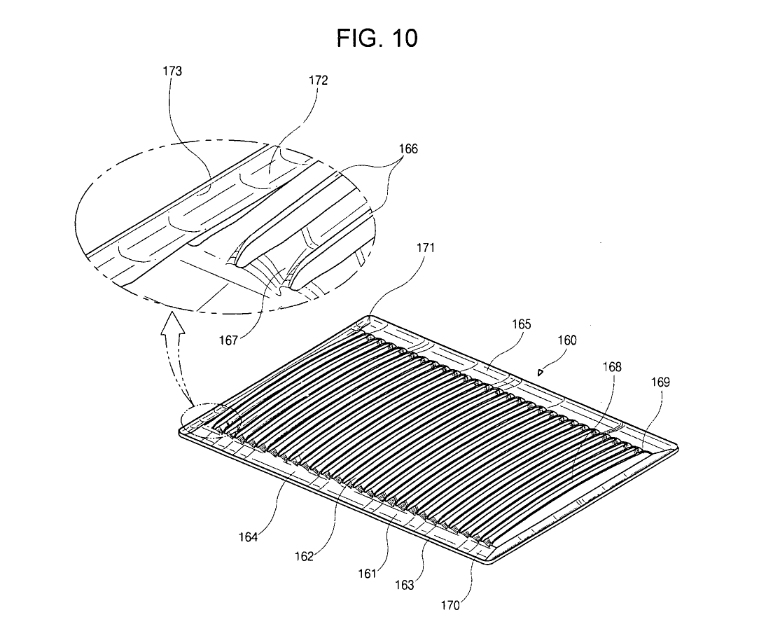

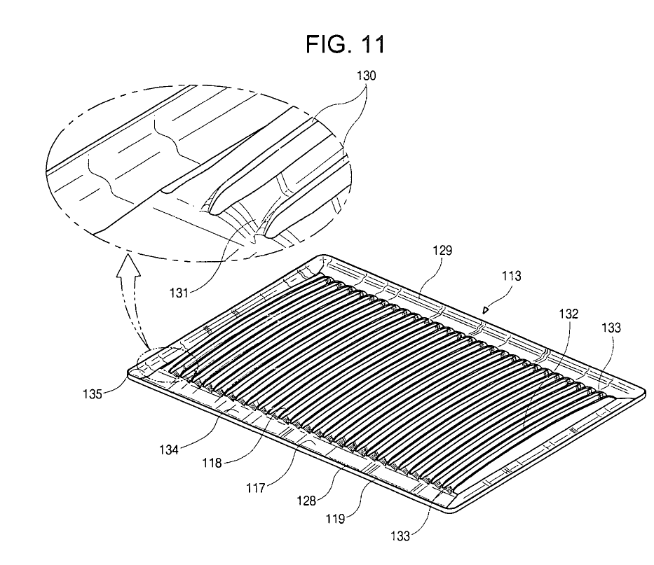

FIG. 8 is a perspective view showing a grill according to a second embodiment of the present invention, and FIGS. 9, 10 and 11 are perspective views showing upper, middle and lower plates of a grill according to a second embodiment of the present invention, respectively.

As shown in FIGS. 8 to 11, a grill 111 includes an upper plate 112, a middle plate 160 combined with the upper plate 112 and a lower plate 113 combined with the middle plate 160. The upper plate 112 includes a first peripheral frame 114 having a tetragonal shape, a plurality of first support frames 115 parallel to and spaced apart from one another inside the first peripheral frame 114 and a first fence 116 surrounding the first peripheral frame 114. The middle plate 160 includes a second peripheral frame 161 having a tetragonal shape, a plurality of second support frames 162 parallel to and spaced apart from one another inside the second peripheral frame 161 and a second fence surrounding the second peripheral frame 161. Further, the lower plate 113 includes a third peripheral frame 117 having a tetragonal shape, a plurality of third support frames 118 parallel to and spaced apart from one another inside the third peripheral frame 117 and a third fence 119 surrounding the third peripheral frame 117.

The first peripheral frame 114 includes first and second long frames 120 and 121 parallel to each other, and each of the plurality of first support frames 115 is connected to the first and second long frames 120 and 121. In addition, each of the plurality of first support frames 115 includes two first side parts 122 to form a first guide path 123. While a meat is roasted, the meat directly contacts the first side parts 122 and remnants extracted from the meat while roasting are guided through the first guide path 123. Each of the plurality of first support frames 115 is highest at a first central portion 124 and lowest at first connection portions 125 where each of the plurality of first support frames 115 is connected to the first and second long frames 120 and 121. Accordingly, each of the plurality of first support frames 115 is gently slanted between the first central portion 124 and the first connection portion 125. A first inclined plane 126 slanted toward the first fence 116 is formed between the first peripheral frame 114 and the first fence 116, and a first gathering part 127 of a moat shape is disposed between the first inclined plane 126 and the first fence 116 to gather remnants of the meat. The first gathering part 127 is formed along an inner surface of the first fence 116.

The second peripheral frame 161 includes third and fourth long frames 164 and 165 parallel to each other, and each of the plurality of second support frames 162 is connected to the third and fourth long frames 164 and 165. In addition, each of the plurality of second support frames 162 includes two second side parts 166 to form a second guide path 167. While a meat is roasted, the remnants of the meat are guided through the second guide path 167. Each of the plurality of second support frames 162 is highest at a second central portion 168 and lowest at second connection portions 169 where each of the plurality of second support frames 162 is connected to the third and fourth long frames 164 and 165. Accordingly, each of the plurality of second support frames 162 is gently slanted between the second central portion 168 and the second connection portion 169. A second inclined plane 170 slanted toward the second fence 163 is formed between the second peripheral frame 161 and the second fence 163, and a second gathering part 171 of a moat shape is disposed between the second inclined plane 170 and the second fence 171 to gather remnants of the meat. The second gathering part 171 is formed along an inner surface of the second fence 171.

The third peripheral frame 117 includes fifth and sixth long frames 128 and 129 parallel to each other, and each of the plurality of third support frames 118 is connected to the fifth and sixth long frames 128 and 129. In addition, each of the plurality of third support frames 118 includes two third side parts 130 to form a third guide path 131. While a meat is roasted, the remnants of the meat are guided through the third guide path 131. Each of the plurality of third support frames 118 is highest at a third central portion 132 and lowest at third connection portions 133 where each of the plurality of third support frames 118 is connected to the fifth and sixth long frames 128 and 129. Accordingly, each of the plurality of third support frames 118 is gently slanted between the third central portion 132 and the third connection portion 133. A third inclined plane 134 slanted toward the third fence 119 is formed between the third peripheral frame 117 and the third fence 119, and a third gathering part 135 of a moat shape is disposed between the third inclined plane 134 and the third fence 119 to gather remnants of the meat. The third gathering part 135 is formed along an inner surface of the third fence 119.

As shown in FIG. 8, when the upper, middle and lower plates 112, 160 and 13 are combined with each other, an outer surface of the first fence 116 of the upper plate 112 contacts an inner surface of the second fence 163 of the middle plate 160 and an outer surface of the second fence 163 of the middle plate 160 contacts an inner surface of the third fence 119 of the lower plate 113. In addition, the first gathering part 127 of the upper plate 112 is disposed over the second gathering part 171 of the middle plate 160 and the second gathering part 171 of the middle plate 160 is disposed over the third gathering part 135 of the lower plate 113. Each of the plurality of second support frames 162 of the middle plate 160 is aligned to a space between adjacent two first support frames 115 of the upper plate 112 and each of the plurality of third support frames 118 of the lower plate 113 is aligned to each of the plurality of second support frames 162 of the middle plate 160. The first and second support frames 115 and 162 do not contact and are spaced apart from each other so that heat from a heat source (not shown) such as a charcoal fire under the grill 111 can be transmitted to the meat on the upper plate 112.

Since the space between adjacent two first support frames 115 corresponds to each of the plurality of second support frames 162, drop of the remnants of the meat on the upper plate 112 onto the heat source is prevented. Further, the plurality of third support frames 118 of the lower plate 113 corresponding to the plurality of second support frames 162 of the middle plate 160 function as a buffer that prevents direct heating of the plurality of second support frames 162 of the middle plate 160 by the heat source and prevents scorch of the remnants in the plurality of second support frames 162. The scorch of the remnants causes smoke and smell to hinder pleasure of meal.

A width of the space between adjacent two first support frames 115 is smaller than a width of each of the plurality of second support frames 162. The grill 111 further includes an adjusting means (not shown) adjusting a vertical gap distance between the plurality of first support frames 115 and the plurality of second support frames 162 to control the heat conduction from the heat source to the upper plate 112. In addition, the grill 111 further includes an outlet at one of the first gathering part 127 of the upper plate 112, the second gathering part 171 of the middle plate 160 and the third gathering part 135 of the lower plate 113 to extract the remnants of the meat.

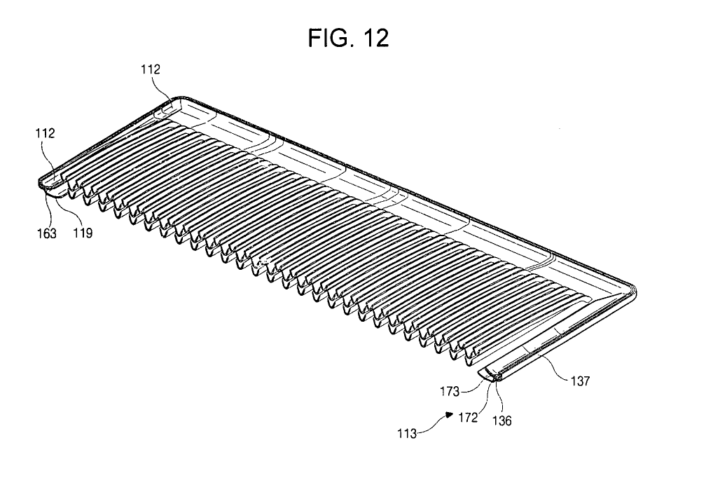

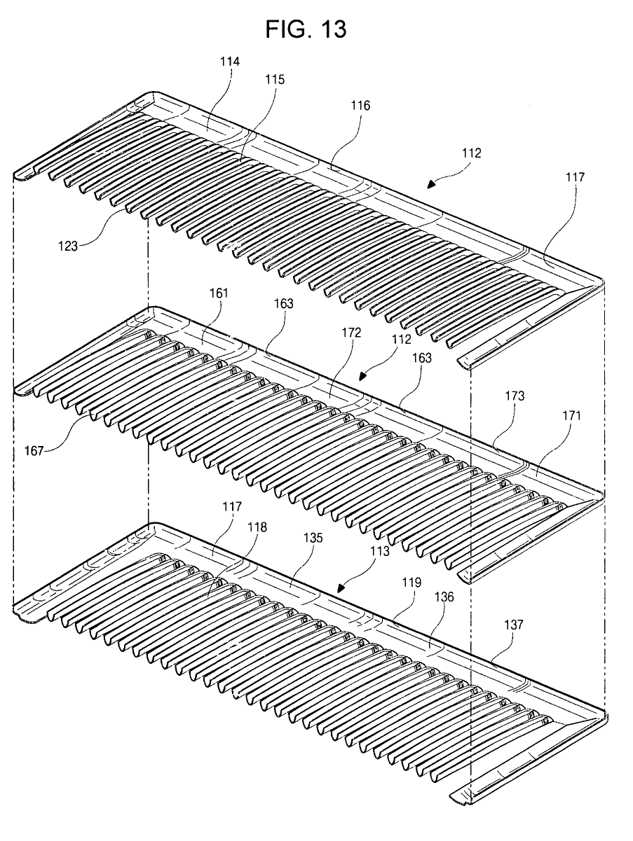

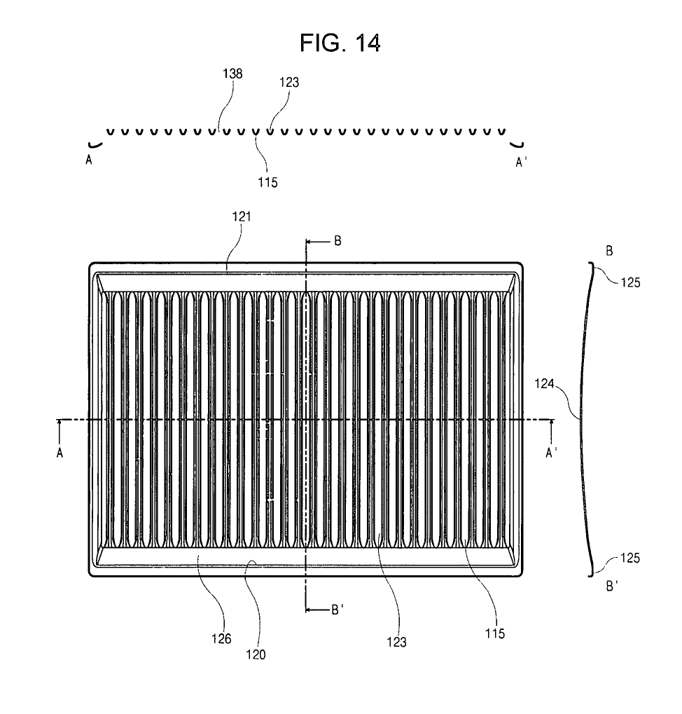

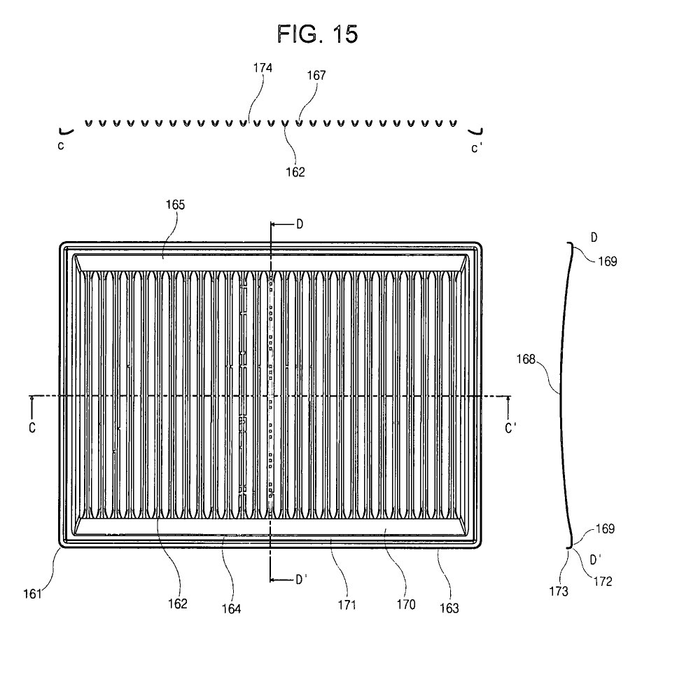

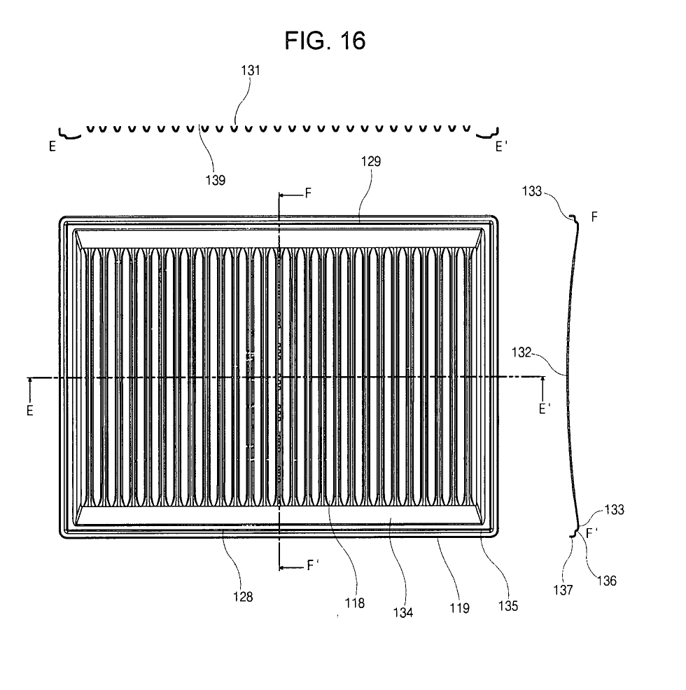

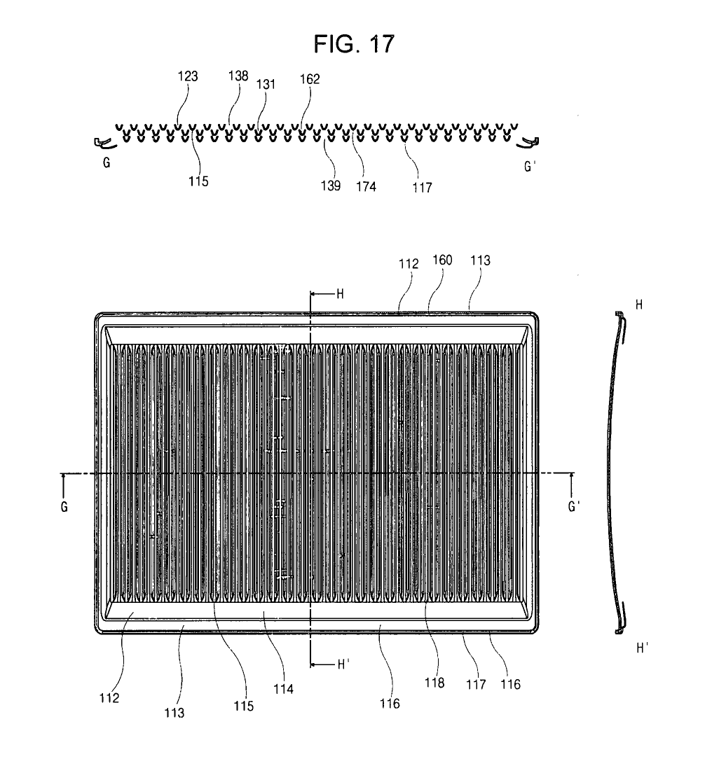

FIG. 12 is a perspective view showing a cut grill according to a second embodiment of the present invention and FIG. 13 is an exploded perspective view showing a cut grill according to a second embodiment of the present invention. FIGS. 14, 15 and 16 are plan views showing upper, middle and lower plates of a grill according to a second embodiment of the present invention, respectively, and FIG. 17 is a plan view showing a grill according to a second embodiment of the present invention. In addition, FIG. 14 shows cross-sections of the upper plate taken along lines “A-A′” and “B-B′,” FIG. 15 shows cross-sections of the middle plate taken along lines “C-C′” and “D-D′,” and FIG. 16 shows cross-sections of the lower plate taken along lines “E-E′” and “F-F′.” FIG. 17 shows cross-sections of the grill taken along lines “G-G′” and “H-H′.”

As shown in FIGS. 12 and 13, an outer surface of the first fence 116 of the upper plate 112 contacts an inner surface of the second fence 163 of the middle plate 160 and an outer surface of the second fence 163 of the middle plate 160 contacts an inner surface of the third fence 119 of the lower plate 113. The second fence 163 of the middle plate 160 includes an upper plate supporting part 172 bending and outwardly extending and an upper plate contact part 173 vertically extending from an end portion of the upper plate supporting part 172 to support the upper plate 112. The upper plate contact part 173 contacts the first fence 116. Further, the third fence 119 of the lower plate 113 includes a middle plate supporting part 136 bending and outwardly extending and a middle plate contact part 137 vertically extending from an end portion of the middle plate supporting part 136 to support the middle plate 160. The middle plate contact part 137 contacts the second fence 163.

Accordingly, in the grill 111 having the combined upper, middle and lower plates 112, 160 and 113, the upper plate 112 is supported by the upper plate supporting part 172 of the middle plate 160 and the middle plate 160 is supported by the middle plate supporting part 136 of the lower plate 113. In addition, the first gathering part 127 of the upper plate 112 and the second gathering part 171 of the middle plate 160 independently gather the remnants of the meat through the first guide path 123 of the plurality of first support frames 115 of the upper plate 112 and the second guide path 167 of the plurality of second support frames 162 of the middle plate 160. Since the plurality of third support frames 118 of the lower plate 113 are aligned to the plurality of second support frames 162 of the middle plate 160, the remnants are seldom guided through the third guide path 131 of the lower plate 113 and the third gathering part 135 of the lower plate 113 does not gather the remnants.

The plurality of first support frames 115 of the upper plate 112 and the plurality of second support frames 162 of the middle plate 160 are spaced apart without contact so that the heat from the heat source such as a charcoal fire can be transmitted to the plurality of first support frames 115 of the upper plate 112. In addition, since the plurality of third support frames 118 of the lower plate 113 is aligned to the plurality of second support frames 162 of the middle plate 160, the plurality of second support frames 162 are blocked by the plurality of third support frames 118 from the heat source and are not directly heated by the heat source.

As shown in FIG. 14, each of the plurality of first support frames 115 is highest at the first central portion 124 and lowest at the first connection portions 125 where each of the plurality of first support frames 115 is connected to the first and second long frames 120 and 121 with respect to the first peripheral frame 114. Accordingly, each of the plurality of first support frames 115 is gently slanted such that the height is lowered from the first central portion 124 to the first connection portion 125. As a result, the remnants of the meat does not stay in the first guide path 123 and are gathered in the first gathering part 127 due to a slant shape of the plurality of first support frames 115. Since the remnants of the meat from the first guide path 123 flow between the first inclined plane 126 and the first fence 116, the remnants of the meat are easily gathered in the first gathering part 127. Accordingly, the amount of the remnants of the meat remaining on the plurality of first support frame 115 of the upper plate 112 corresponding to the heat source is minimized. Further, the plurality of first support frames 115 are parallel to and spaced apart from one another by a first space 138 and each of the plurality of second support frames 162 of the middle plate 160 corresponds to the first space 138.

As shown in FIG. 15, each of the plurality of second support frames 162 is highest at the second central portion 168 and lowest at the second connection portions 169 where each of the plurality of second support frames 162 is connected to the third and fourth long frames 164 and 165 with respect to the second peripheral frame 161. Accordingly, each of the plurality of second support frames 162 is gently slanted such that the height is lowered from the second central portion 168 to the second connection portion 169. As a result, the remnants of the meat does not stay in the second guide path 167 and are gathered in the second gathering part 171 due to a slant shape of the plurality of second support frames 162. Since the remnants of the meat from the second guide path 167 flow between the second inclined plane 170 and the second fence 163, the remnants of the meat are easily gathered in the second gathering part 171. Accordingly, the amount of the remnants of the meat remaining on the plurality of second support frame 162 of the middle plate 160 corresponding to the heat source is minimized. Further, the plurality of second support frames 162 are parallel to and spaced apart from one another by a second space 174 and each of the plurality of first support frames 115 corresponds to the second space 174.

As shown in FIG. 16, each of the plurality of third support frames 118 is highest at the third central portion 132 and lowest at the third connection portions 133 where each of the plurality of third support frames 118 is connected to the fifth and sixth long frames 128 and 129 with respect to the third peripheral frame 117. Accordingly, each of the plurality of third support frames 118 is gently slanted such that the height is lowered from the third central portion 132 to the third connection portion 133. Since the plurality of third support frames 118 of the lower plate 113 are aligned to the plurality of second support frames 162 of the middle plate 160, the plurality of second support frames 162 are blocked by the plurality of third support frames 118 from the heat source and are not directly heated by the heat source. The plurality of third support frames 118 functions as a heat buffer. Further, the plurality of third support frames 118 are parallel to and spaced apart from one another by a third space 139 and each of the plurality of first support frames 115 of the upper plate 112 corresponds to the third space 139.

Referring to the cross-section taken along line “H-H′” of FIG. 17, since the plurality of first support frames 115 of the upper plate 112 correspond to the plurality of second spaces 174 of the middle plate 160, the plurality of second support frames 162 of the middle plate 160 and the plurality of third support frames 118 of the lower plate 113 are not shown, and the second space 174 of the middle plate 160 and the third space 139 of the lower plate 113 are disposed under the first support frame 115. Referring to the cross-section taken along line “G-G′” of FIG. 17, the plurality of first support frames 115 of the upper plate 112 are parallel to and spaced apart from one another by the first space 138. The plurality of second support frames 162 of the middle plate 160 are parallel to and spaced apart from one another by the second space 174 and the plurality of third support frames 118 of the lower plate 113 are parallel to and spaced apart from one another by the third space 139. In addition, each of the plurality of second support frames 162 and the plurality of third support frames 118 corresponds to the first space 138 of the first plate 112. The width of each of the plurality of first support frames 115 of the upper plate 112 is greater than each of the second space 174 of the middle plate 160 and the third space 139 of the lower plate 113. Similarly, the width of each of the plurality of second support frames 162 of the middle plate 160 and the plurality of third support frames 118 of the lower plate 113 is greater than the first space 38 of the upper plate 112. Accordingly, the plurality of first support frames 115 overlap the plurality of second support frames 162 and the plurality of third support frames 118 at their side portions so that drop of the remnants on the plurality of first support frames 115 of the upper plate 112 onto the heat source can be prevented.

Each of the plurality of first support frames 115, the plurality of second support frames 162 and the plurality of third support frames 118 has a cross-sectional shape such that a width is gradually reduced from an upper portion to a lower portion. The lowest portion of the cross-sectional shape is rounded. For example, the cross-sectional shape of the plurality of first support frames 115, the plurality of second support frames 162 and the plurality of third support frames 118 may have a triangular shape or a U shape. At least one outlet (not shown) is further formed at each of the first, second and third gathering parts 127, 171 and 135 to prevent overflow of the remnants. Further, the grill 111 includes a metallic material having a relatively high heat conductivity such as aluminum (Al). The surface of the grill 111 may be enameled or coated with Teflon.

The process of roasting a meat using the grill 111 according to a second embodiment of the present invention will be illustrated hereinafter. When the upper, middle and lower plates 112, 160 and 113 are combined, the first peripheral frame 114 of the upper plate 112 is disposed on the upper plate supporting part 172 of the middle plate 160 and the outer surface of the first fence 116 of the upper plate 112 contacts the inner surface of the second fence 163 of the middle plate 160. In addition, the second peripheral frame 161 of the middle plate 160 is disposed on the middle plate supporting part 136 of the lower plate 113 and the outer surface of the second fence 163 of the middle plate 160 contacts the inner surface of the third fence 119 of the lower plate 113. Further, each of the plurality of first support frames 115 of the upper plate 112 is aligned to the second space 174 of the middle plate 160 and the third space 139 of the lower plate 113, and each of the plurality of second support frames 162 of the middle plate 160 and the plurality of third support frames 118 of the lower plate 113 is aligned to the first space 138 of the upper plate 112. The plurality of first support frames 115 of the upper plate 112 are spaced apart from the plurality of second support frames 162 of the middle plate 160 so that the heat of the heat source under the grill 111 can be applied to the upper plate 112.

The heat source such as a charcoal fire is disposed under the grill 111 and the meat is disposed on the plurality of first support frames 115 of the upper plate 112. The heat source heats the plurality of third support frames 118 of the lower plate 113 and the heat of the heat source is supplied through a space between the plurality of first support frames 115 and the plurality of second support frames 162 to heat the plurality of first support frames 115. Since the meat contacts a top surface of the two first side parts 122 of each first support frame 115, the contact area of the meat and the upper plate 112 is minimized. Further, since the plurality of second support frames 162 of the middle plate 160 and the plurality of third support frames 118 of the lower plate 113 are disposed under the plurality of first support frames 115 of the upper plate 112, the meat does not directly contact the middle plate 160 and the lower plate 113. The meat is roasted by the plurality of first support frames 115 heated by the heat source and the heat supplied through the space between the plurality of first support frames 115 and the plurality of second support frames 162. As a result, the scorch of the meat is prevented due to the minimization of the contact area. Moreover, since the plurality of third support frames 118 of the lower plate 113 are aligned to the plurality of second support frames 162 of the middle plate 160, the plurality of second support frames 162 are not directly heated by the heat source and the scorch of the remnants in the plurality of second support frames 162 is prevented. Accordingly, the smoke and the smell caused by the scorch are also prevented.

When the meat is roasted, the remnants such as grease are extracted from the meat and are guided through the first and second guide paths 123 and 167. The remnants in the first and second guide paths 123 and 167 heated by the heat source are evaporated and permeate into the entire meat to cause a marbling effect. The remnants except the evaporated amount are gathered in the first gathering part 127 of the upper plate 112 and the second gathering part 171 of the middle plate 160 through the first and second guide paths 123 and 167. Since the plurality of first support frames 115 overlap the plurality of second support frames 162 and the plurality of third frames 118 at their side portions, the remnants do not drop onto the heat source.

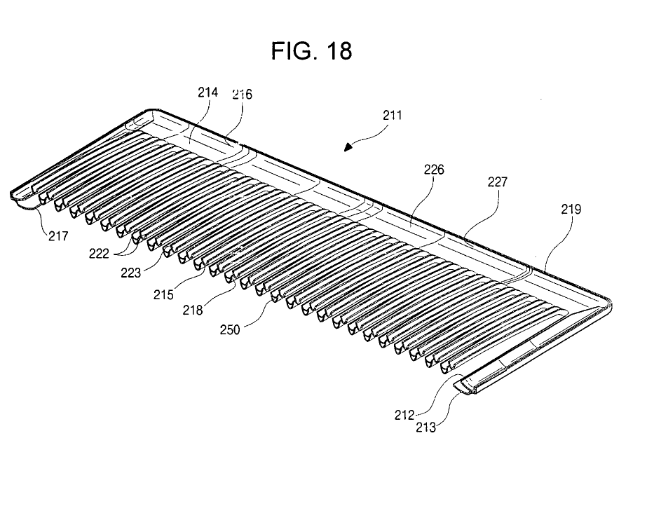

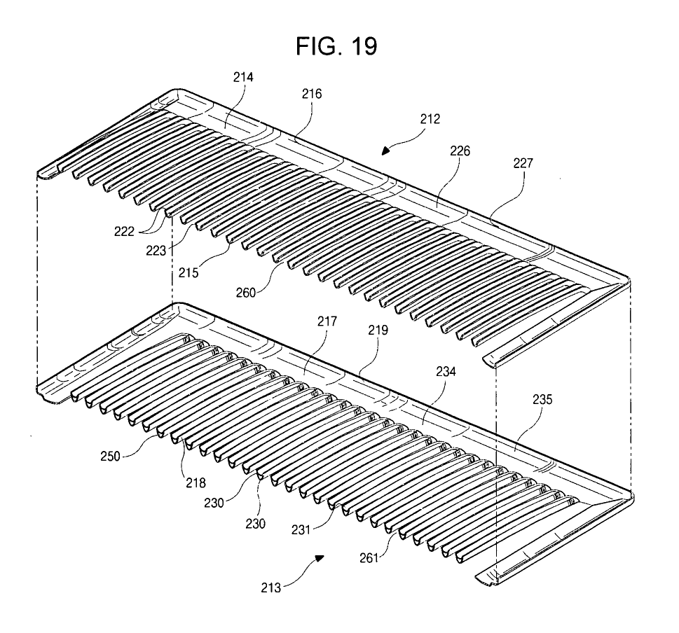

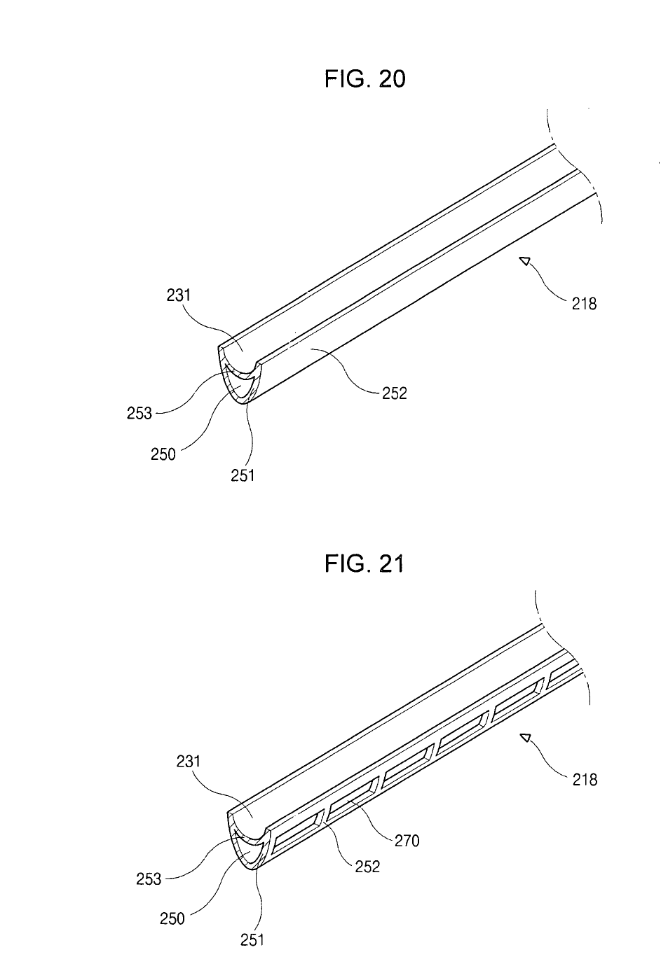

FIG. 18 is a perspective view showing a cut grill according to a third embodiment of the present invention and FIG. 19 is an exploded perspective view showing a cut grill according to a third embodiment of the present invention. FIG. 20 is a perspective view showing a cut second support frame having a continuous side part of a grill according to a third embodiment of the present invention and FIG. 21 is a perspective view showing a cut second support frame having a punched side part of a grill according to a third embodiment of the present invention.

As shown in FIGS. 18 and 19, a grill 211 includes an upper plate 212 and a lower plate 213 combined with the upper plate 212. The upper plate 212 includes a first peripheral frame 214, a plurality of first support frames 215 and a first fence 216, and the lower plate 213 includes a second peripheral frame 217, a plurality of second support frames 218 and a second fence 219. The first and second peripheral frames 214 and 217 have a tetragonal shape. The plurality of first support frames 215 are parallel to and spaced apart from one another inside the first peripheral frame 214, and the plurality of second support frames 218 are parallel to and spaced apart from one another inside the second peripheral frame 217. In addition, the first and second fences 216 and 219 surround the first and second peripheral frames 214 and 217, respectively.

Each of the plurality of first support frames 215 includes two first side parts 222 to form a first guide path 223. While a meat is roasted, the meat directly contacts the first side parts 222 and remnants extracted from the meat while roasting are guided through the first guide path 223. A first inclined plane 226 slanted toward the first fence 216 is formed between the first peripheral frame 214 and the first fence 216, and a first gathering part 227 of a moat shape is disposed between the first inclined plane 226 and the first fence 216 to gather remnants of the meat. The first gathering part 227 is formed along an inner surface of the first fence 216.

Each of the plurality of second support frames 218 includes two second side parts 230 to form a second guide path 231. While a meat is roasted, the remnants of the meat are guided through the second guide path 231. A second inclined plane 234 slanted toward the second fence 219 is formed between the second peripheral frame 217 and the second fence 219, and a second gathering part 235 of a moat shape is disposed between the second inclined plane 234 and the second fence 219 to gather remnants of the meat. The second gathering part 235 is formed along an inner surface of the second fence 219.

As shown in FIG. 18, when the upper and lower plates 212 and 213 are combined with each other, an outer surface of the first fence 216 of the upper plate 212 contacts an inner surface of the second fence 219 of the lower plate 213 and the first gathering part 227 of the upper plate 212 is disposed over the second gathering part 235 of the lower plate 213. Each of the plurality of second support frames 218 of the lower plate 213 is aligned to a space between adjacent two first support frames 215 of the upper plate 212. The first and second support frames 215 and 218 do not contact and are spaced apart from each other so that heat from a heat source (not shown) such as a charcoal fire under the grill 211 can be transmitted to the meat on the upper plate 212.

Each of the plurality of second frames 218 of the lower plate 213 includes a bottom part 251, a side part 252 and a top part 253 constituting a cavity 250. In addition, a top surface of the top part 253 constitutes the second guide path 231 guiding the remnants of the meat. The bottom part 251 is directly heated by the heat source and the side part 252 is formed at both sides of the bottom part 251. The bottom and side parts 251 and 252 function as a buffer that prevents direct heating of the top part 253 by the heat source and prevents the smoke and smell due to scorch of the remnants in the second guide path 231. Since the bottom and side parts 251 and 252 functioning as a heat buffer are integrated with the top part 253 to form each of the plurality of second support frames 218, the grill 211 according to a third embodiment of the present invention has advantages in combination and separation of plates of the grill 211.

In FIG. 20, the side part 252 of each of the plurality of second support frames 218 has a continuous surface without windows for exhausting heated air in the cavity 250. Instead, an exhaust is formed at one of ends of each of the plurality of second support frames 218 for exhausting heated air in the cavity 250. In FIG.21, the side part 252 of each of the plurality of second support frames 218 has a punched surface with windows 270 for exhausting heated air in the cavity 250 and the connection area between the side part 252 and the top part 253 is minimized. Accordingly, the heated air in the cavity 250 is excellently exhausted and the heat conduction from the bottom part 251 directly heated by the heat source to the top part 253 is minimized. As a result, the scorch of the remnants in the second guide path 231 is further prevented.

Consequently, in the grill according to the present invention, since the contact area between the meat and the grill is minimized, the scorch of the meat is prevented. In addition, since the remnants such as grease are re-evaporated in the guide path and permeate into the meat, a marbling effect is caused to improve quality of the meat. Further, since the heat conduction to the guide path having the remnants is reduced, the scorch of the remnants is prevented. Finally, since the grill is separated into plates, the grill is easily cleaned.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A grill for roasting a meat, comprising:
a peripheral frame;
a plurality of first support frames connected to the peripheral frame, the plurality of first support frames parallel to and spaced apart from one another by a first space; and
a plurality of second support frames under the plurality of first support frames, the plurality of second support frames parallel to and spaced apart from one another by a second space, each of the plurality of second support frames corresponding to the first space.

2. The grill according to claim 1, wherein the peripheral frame includes an upper plate and a lower plate under the upper plate, and wherein the upper plate has a first peripheral frame connected to the plurality of first support frames and the lower plate has a second peripheral frame connected to the plurality of second support frames.

3. The grill according to claim 2, wherein each of the plurality of first support frames includes a first central portion, a first connection portion connected to first and second long frames of the first peripheral frame and a first inclined plane lowered from the first central portion to the first connection portion, and wherein each of the plurality of second support frames includes a second central portion, a second connection portion connected to third and fourth long frames of the second peripheral frame and a second inclined plane lowered from the second central portion to the second connection portion.

4. The grill according to claim 2, further comprising a first fence and a second fence surrounding the first peripheral frame and the second peripheral frame, respectively.

5. The grill according to claim 4, further comprising a first gathering part formed along an inner surface of the first fence and a second gathering part formed along an inner surface of the second fence, wherein the first and second gathering parts have a moat shape.

6. The grill according to claim 5, further comprising an outlet formed at one of the first and second gathering parts.

7. The grill according to claim 4, wherein the lower plate includes an upper plate supporting part extending to the second fence and an upper plate contact part vertically extending from an end portion of the upper plate supporting part to contact the first fence.

8. The grill according to claim 1, wherein each of the plurality of first support frames and the plurality of second support frames includes two side parts and a guide path between the two side parts for guiding remnants of the meat.

9. The grill according to claim 8, wherein a cross-sectional shape of each of the plurality of first support frames and the plurality of second support frames has one of a triangular shape and a U shape.

10. The grill according to claim 1, wherein a width of each of the plurality of first support frames is greater than a width of the second space, and a width of each of the plurality of second support frames is greater than a width of the first space.

11. The grill according to claim 1, wherein the plurality of first support frames overlap the plurality of second support frames at side portions thereof.

12. The grill according to claim 1, wherein the plurality of first support frames are spaced apart from the plurality of second support frames.

13. The grill according to claim 2, wherein a surface of the upper and lower plates is coated with one of enamel and Teflon.

14. The grill according to claim 1, further comprising a means adjusting a vertical gap distance between the plurality of first support frames and the plurality of second support frames.

15. The grill according to claim 1, further comprising a plurality of third support frames under the plurality of second support frames, wherein each of the plurality of third support frames corresponds to the first space.

16. The grill according to claim 15, wherein the peripheral frame includes an upper plate, a middle plate under the upper plate and a lower plate under the middle plate, and wherein the upper plate has a first peripheral frame connected to the plurality of first support frames, the middle plate has a second peripheral frame connected to the plurality of second support frames, and the lower plate has a third peripheral frame connected to the plurality of third support frames.

17. The grill according to claim 16, wherein each of the plurality of first support frames includes a first central portion, a first connection portion connected to first and second long frames of the first peripheral frame and a first inclined plane lowered from the first central portion to the first connection portion, wherein each of the plurality of second support frames includes a second central portion, a second connection portion connected to third and fourth long frames of the second peripheral frame and a second inclined plane lowered from the second central portion to the second connection portion, and wherein each of the plurality of third support frames includes a third central portion, a third connection portion connected to fifth and sixth long frames of the third peripheral frame and a third inclined plane lowered from the third central portion to the third connection portion.

18. The grill according to claim 16, further comprising a first fence surrounding the first peripheral frame, and a second fence surrounding the second peripheral frame and a third fence surrounding the third peripheral frame.

19. The grill according to claim 18, further comprising a first gathering part formed along an inner surface of the first fence, a second gathering part formed along an inner surface of the second fence and a third gathering part formed along an inner surface of the third fence, wherein the first, second and third gathering parts have a moat shape.

20. The grill according to claim 18, further comprising an outlet formed at one of the first, second and third gathering parts.

21. The grill according to claim 18, wherein the middle plate includes an upper plate supporting part extending to the second fence and an upper plate contact part vertically extending from an end portion of the upper plate supporting part to contact the first fence, and wherein the lower plate includes an middle plate supporting part extending to the third fence and an middle plate contact part vertically extending from an end portion of the middle plate supporting part to contact the second fence.

22. The grill according to claim 15, wherein each of the plurality of first support frames, the plurality of second support frames and the plurality of third support frames includes two side parts and a guide path between the two side parts for guiding remnants of the meat.

23. The grill according to claim 15, wherein a width of each of the plurality of first support frames is greater than a width of the second space, and a width of each of the plurality of second support frames and the plurality of third support frames is greater than a width of the first space.

24. The grill according to claim 15, wherein the plurality of first support frames overlap the plurality of second support frames and the plurality of third support frames at side portions thereof.

25. The grill according to claim 15, wherein the plurality of first support frames are spaced apart from the plurality of second support frames, and the plurality of second support frames are spaced apart from the plurality of third support frames.

26. The grill according to claim 15, further comprising a means adjusting a first vertical gap distance between the plurality of first support frames and the plurality of second support frames and a second vertical gap distance between the plurality of second support frames and the plurality of third support frames.

27. The grill according to claim 2, wherein each of the plurality of second support frames has a cavity therein.

28. The grill according to claim 27, wherein each of the plurality of second support frames includes a bottom part, a side part formed at both sides of the bottom part and a top part constituting the cavity, and wherein a top surface of the top part constitutes a guide path.

29. The grill according to claim 27, wherein each of the plurality of second support frames includes an exhaust at one of ends thereof.

30. The grill according to claim 27, wherein the side part of each of the plurality of second support frames includes a window.

31. The grill according to claim 27, wherein the peripheral frame includes an upper plate and a lower plate under the upper plate, and wherein the upper plate has a first peripheral frame connected to the plurality of first support frames and the lower plate has a second peripheral frame connected to the plurality of second support frames.

32. The grill according to claim 30, further comprising a first fence and a second fence surrounding the first peripheral frame and the second peripheral frame, respectively.

33. The grill according to claim 30, further comprising a first gathering part formed along an inner surface of the first fence and a second gathering part formed along an inner surface of the second fence, wherein the first and second gathering parts have a moat shape.
